(19) United States
(12) Patent Application Publication
(10) Pub. No.: US 2018/0141127 A1
(43) Pub. Date: May 24, 2018

(54) METHOD OF MANUFACTURING A COMPONENT WITH PASSAGES

(71) Applicant: PRATT & WHITNEY CANADA CORP., Longueuil (CA)

(72) Inventor: Francois RICHARD, St-Denis-sur-Richelieu (CA)

(21) Appl. No.: 15/357,447

(22) Filed: Nov. 21, 2016

(51) Int. Cl. B22F 3/24; B33Y 10/00; B33Y 40/00; B33Y 80/00; B05D 1/12; B05D 7/14; B23K 26/00; B23K 26/342; B23K 15/00; B23H 9/14; B22F 3/105; C23C 24/04

(52) U.S. Cl. CPC B22F 3/24; B33Y 10/00; B33Y 40/00; B33Y 80/00; B05D 1/12; B05D 7/14; B22F 2003/247; B23K 26/342; B23K 15/0086; B23H 9/14; B22F 3/1055; C23C 24/04; B23K 26/0093

(57) ABSTRACT

A method of manufacturing a component with passages extending therethrough, including manufacturing a portion of the component using an additive manufacturing process, including creating the passages within the portion of the component, and adding material directly on the portion of the component using a material build-up process different from the first additive manufacturing process until a predetermined shape for the component is obtained. The component may be a wall of a housing of a rotary internal combustion engine.

### TECHNICAL FIELD

The application relates generally to the manufacture of components having passages defined therethrough and, more particularly, to the manufacture of such components using additive manufacturing.

### BACKGROUND OF THE ART

Components with passages may be formed using powder bed additive manufacturing processes, which allow for complex passage geometries to be created. However, such processes are limited by the size of the powder bed of the additive manufacturing equipment. Moreover, the associated costs with such manufacturing processes may be relatively high.

### SUMMARY

In one aspect, there is provided a method of manufacturing a component with passages extending therethrough, the method comprising: a) manufacturing a portion of the component using an additive manufacturing process, including creating the passages within the portion of the component; and b) after step a), adding material directly on the portion of the component using a material build-up process different from the additive manufacturing process of step a) until a predetermined shape for the component is obtained.

In another aspect, there is provided a method of manufacturing a wall of a housing of a rotary internal combustion engine, the housing defining an internal cavity sealingly receiving a rotor, the method comprising: a) manufacturing a portion of the wall using an additive manufacturing process, including creating cooling passages through the portion of the wall; and b) after step a), building up material directly on the portion of the wall using a manufacturing process different from the additive manufacturing process of step a) to manufacture a remainder of the wall.

### DESCRIPTION OF THE DRAWINGS

Reference is now made to the accompanying figures in which:

FIG. 1 is a block diagram of a manufacturing method in accordance with a particular embodiment;

FIGS. 2-5 are schematic cross-sectional views of a component during different steps of the method of FIG. 1, in accordance with a particular embodiment; and

FIG. 6 is a schematic cross-sectional view of an exemplary rotary engine having a housing which may be manufactured using the method of FIG. 1.

### DETAILED DESCRIPTION

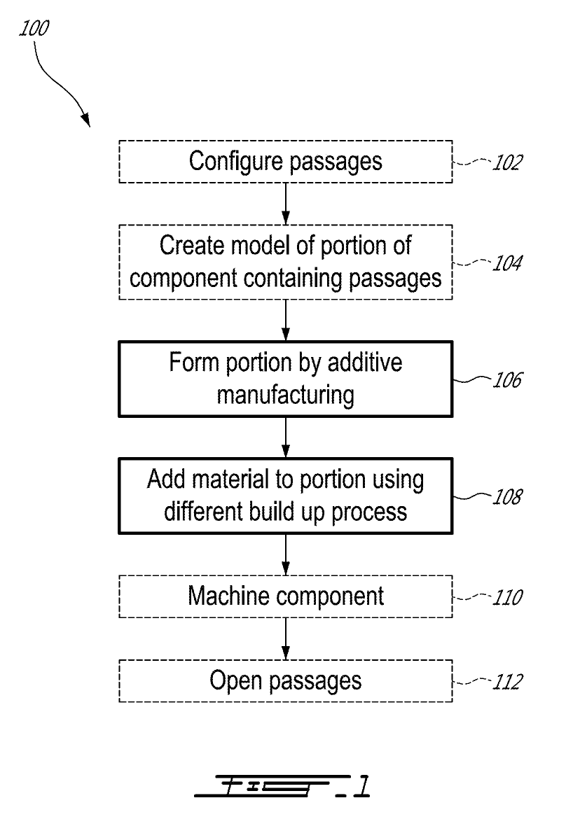

Referring to FIG. 1, a particular embodiment of a method 100 of manufacturing a component having passages defined therethrough, for example passages for circulating a liquid coolant, is generally shown.

As illustrated in step 102, the passages are configured, e.g. the number, size and path of the passages is determined. If the passages are cooling passages, this can be done for example based on the cooling requirements of the component. The passages can be configured to define conformal cooling channels, i.e. cooling passages that follow the profile of the hot zone(s) of the component to increase the efficiency of the cooling process. For example, a simulation of operations conditions can be performed to determine the hot zone(s) of the component, and the cooling passages can be configured to circulate through (or, when not possible, around in close proximity to) the hot zone(s).

Once the configuration of the passages (e.g. number, size and path) is determined, a model of a portion of the component containing the passages (hereinafter, “passage portion”) is created, as illustrated in step 104. The model includes sufficient material around the passages so as to define a self-supporting structure, i.e. the passage portion can maintain its shape and support its own weight. In a particular embodiment, the model minimizes the amount of material surrounding the passages. Other configurations may alternately be used. For example, the shape of the passage portion may be determined by the shape of the powder bed which will be used to create it, as set forth further below. In a particular embodiment, the model of the passage portion is created using CAD software compatible for use in the following manufacturing process.

Alternately, the passage portion may be manufactured from an existing model or using any other appropriate method to define the path and size of the passages, and steps 102 and 104 may be omitted.

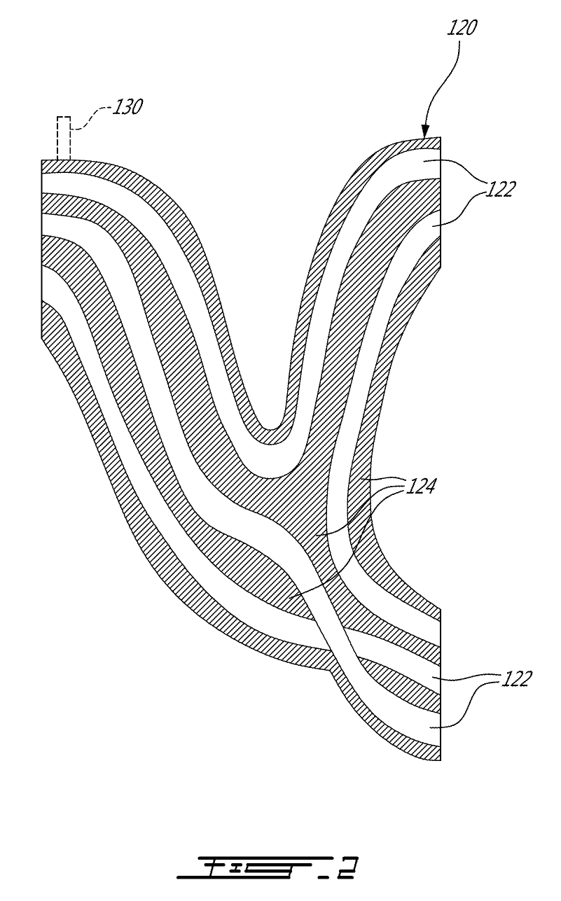

As illustrated in step 106 of FIG. 1 and referring to FIG. 2, the passage portion 120 is created, for example from the model, using an additive manufacturing process; the passage portion 120 includes the passages 122 surrounding by solid material 124.

In a particular embodiment, the additive manufacturing process used to create the passage portion 120 is a powder bed fusion process using a laser. In a powder bed fusion process, the component is created layer by layer from a bed of powder material. A laser or another suitable heat source (e.g. electron beam, heated thermal print head) is used to fuse the powder material together (e.g. by melting the powder material) to create a layer of the component. New powder material is spread over the layer of the component, for example using a blade or a roller, and the next layer is created. The process is repeated until the passage portion 120 is complete; the cooling passages 122 are created as the passage portion 120 is manufactured.

Examples of suitable additive manufacturing processes that can be used to create the passage portion 120 include, but are not limited to, Direct metal laser sintering (DMLS), Electron beam melting (EBM), Selective heat sintering (SHS), Selective laser melting (SLM) and Selective laser sintering (SLS).

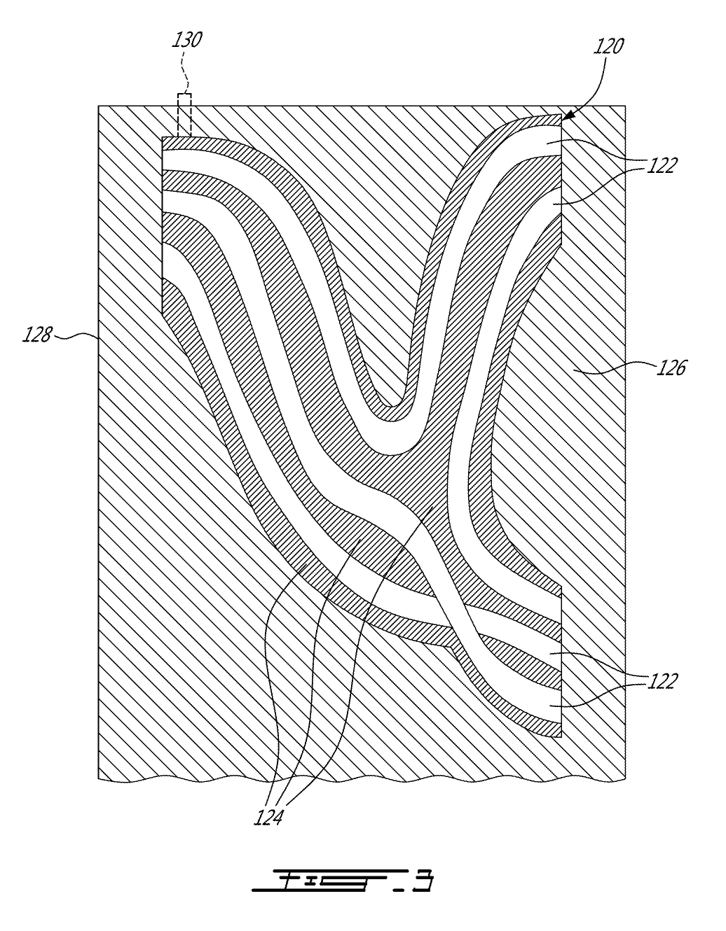

Once the passage portion 120 is formed, the passage portion 120 is disengaged from the machine used to create it, e.g. removed from the powder bed. As illustrated in step 108 of FIG. 1 and referring to FIG. 3, the remainder of the component is created by adding material 126 directly on the passage portion 120 using a material build-up process different from the additive manufacturing process used to create the passage portion 120. Material 126 is added on the passage portion until a predetermined shape 128 for the component is obtained. For example, in a particular embodiment the remainder of the component is created with the material build-up process by forming successive layers over the passage portion 120. In a particular embodiment, the passage portion 120 is embedded (e.g., completely or substantially completely surrounded) by the material 126 added in the material build-up process. In a particular embodiment, the passage portion 120 is no longer visible after the material build-up process of step 108 is performed.

In a particular embodiment, the added material 126 is the same material (e.g., same metal or alloy) as the solid material 124 of the passage portion 120. Alternately, different materials may be used.

In a particular embodiment, the material build-up process of step 108 is an additive manufacturing process which does not require the use of a powder bed. Suitable processes include, but are not limited to, Powder Directed Energy Deposition processes and Wire Directed Energy Deposition processes.

In Powder Directed Energy Deposition processes, powder material is blown through a nozzle on the surface of the part, and the powder is melted by a laser beam on the surface of the part. Examples of Powder Directed Energy Deposition processes include Laser Metal Deposition-powder (LMD-p) and Laser Engineered Net Shaping (LENS). Powder material is thus blown over the surface of the passage portion 120 and melted with the laser beam to form the remainder of the component.

In Wire Directed Energy Deposition processes, a wire is fed through a nozzle and the wire is melted, for example by a laser, to add material to the part. Inert gas shielding is provided in either an open environment (gas surrounding the laser), or in a sealed gas enclosure or chamber. Examples of Wire Directed Energy Deposition processes include Laser Metal Deposition-wire (LMD-w), Electron Beam Additive Manufacturing (EBAM), and Tungsten Inert Gas (TIG). Material from the melted wire is thus added on the surface of the passage portion 120 to form the remainder of the component.

Other suitable material build-up processes include, but are not limited to, cold spray, cold metal transfer processes, casting and molding processes. In cold spray, particles of solid material are accelerated in a supersonic jet and undergo plastic deformation upon impact with the surface of the part. The deformation causes the particles to adhere to the part and form a coating. The remainder of the component is thus formed by successive coating layers applied directly on the passage portion 120. In cold metal transfer, metal is melted (similar to a welding process) and deposited on the surface of the passage portion 120.

In a particular embodiment, one or more reference point(s) 130 are retained or defined on the component as the material 126 is build-up over the passage portion 120, so as to be able to locate the passages 122 once the passage portion 120 is embedded in the additional material 126. The reference point(s) 130 can be defined by a remaining exposed part of the passage portion 120 or by the added material 126.

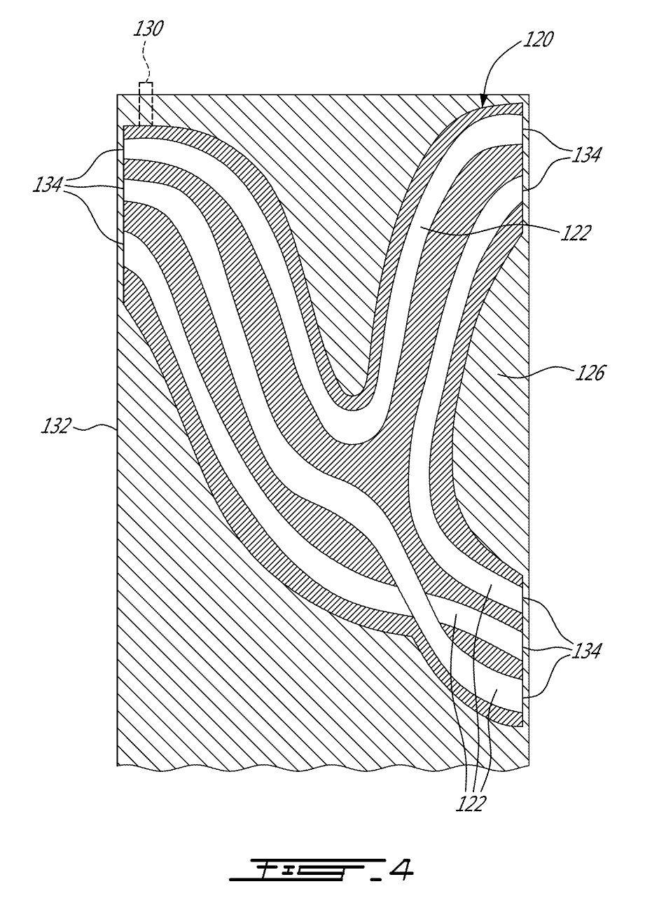

In the particular embodiment shown in FIG. 3, the material build-up process of step 108 created a predetermined shape 128 larger than the desired shape 132 for the component. Accordingly, as illustrated in step 110 of FIG. 1 and referring to FIG. 4, the component is machined to the desired shape 132 after the material build-up process of step 108. Any suitable machining process may be used, including, but not limited to, cutting, sanding, knurling, drilling, facing, turning, milling, and grinding.

In a particular embodiment, the predetermined shape 128 obtained through the material build-up process of step 108 corresponds to the desired shape of the finished component. Step 110 of FIG. 1 may accordingly be omitted.

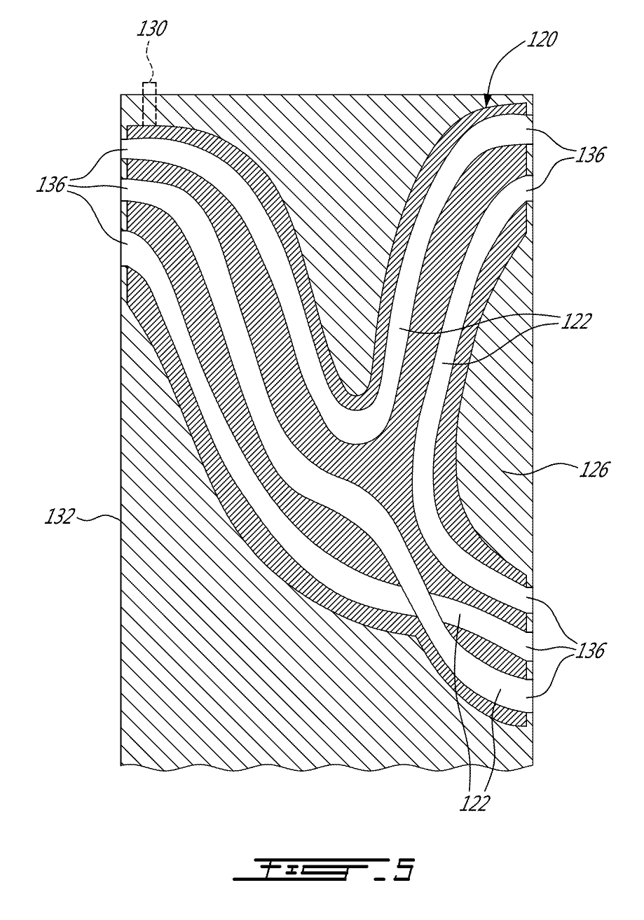

In a particular embodiment, the ends 134 of the passages 122 remain blocked after the component is machined, for example to avoid debris from the machining process entering the passages 122. Accordingly, as illustrated in step 112 of FIG. 1 and referring to FIG. 5, the surface of the component is machined to form openings 136 at the ends of the passages 122 in communication with the passages 122, using a process that does not generate debris inside the passages 122. For example, electric discharge machining (EDM) may be used; other suitable processes include, but are not limited to, waterjet machining and electrochemical machining (ECM). Alternately, the passages 122 may be opened during the preceding machining step 110. Step 112 of FIG. 1 may accordingly be omitted.

In a particular embodiment, two or more portions 120 of the component including cooling passages 122 are manufactured by additive manufacturing in step 104, for example through a powder bed fusion process. The passage portions 120 are then interconnected with the material 126 added during the subsequent material build-up process in step 108, as the remainder of the component is created.

In a particular embodiment, the above method allows to use a powder bed additive manufacturing process to manufacture a component including passages 120 (e.g. cooling passages) even when the component is larger than the maximum size allowed by the bed of powder material. Passage portion(s) 120 sized to fit in the powder bed is/are manufactured using the powder bed additive manufacturing process, and the remainder of the component is manufactured by adding layers of material directly on the passage portion(s) 120, using another material build-up process not constrained by the size of a bed of powder material. Complex passage geometries can thus be created in components that are larger than the powder bed of the additive manufacturing equipment.

In a particular embodiment, the material build-up process is less expensive than the additive manufacturing process used to manufacture the passage portion(s) 120; accordingly, the combination of processes allow for a reduced manufacturing cost as compared to using the initial additive manufacturing process to manufacture the whole component.

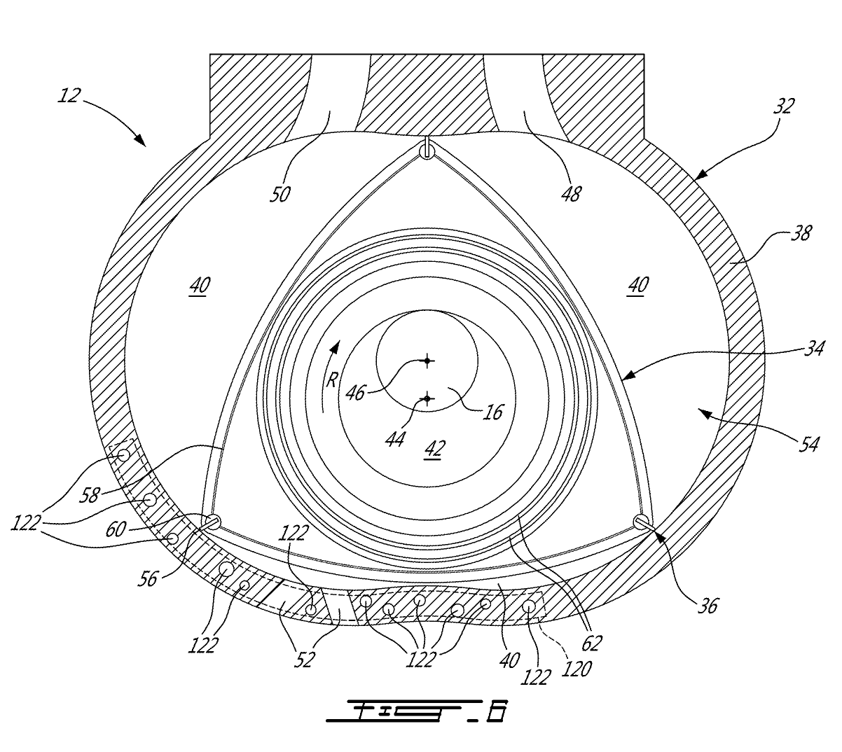

In a particular embodiment and referring to FIG. 6, the method 100 is used to manufacture a part or a whole of a housing of a Wankel rotary engine 12. The engine 12 comprises a housing 32 defining a rotor cavity having a profile defining two lobes, which is preferably an epitrochoid. A rotor 34 is received within the rotor cavity. The rotor defines three circumferentially-spaced apex portions 36, and a generally triangular profile with outwardly arched sides. The apex portions 36 are in sealing engagement with the inner surface of a peripheral wall 38 of the housing 32 to form and separate three working chambers 40 of variable volume between the rotor 34 and the housing 32. The peripheral wall 38 extends between two axially spaced apart end walls 54 to enclose the rotor cavity.

The rotor 34 is engaged to an eccentric portion 42 of an output shaft 16 to perform orbital revolutions within the rotor cavity. The output shaft 16 performs three rotations for each orbital revolution of the rotor 34. The geometrical axis 44 of the rotor 34 is offset from and parallel to the axis 46 of the housing 32. During each orbital revolution, each chamber 40 varies in volume and moves around the rotor cavity to undergo the four phases of intake, compression, expansion and exhaust.

An intake port 48 is provided through the peripheral wall 38 for admitting compressed air into one of the working chambers 40. An exhaust port 50 is also provided through the peripheral wall 38 for discharge of the exhaust gases from the working chambers 40. Passages 52 for a spark plug, glow plug or other ignition mechanism, as well as for one or more fuel injectors of a fuel injection system (not shown) are also provided through the peripheral wall 38. Alternately, the intake port 48, the exhaust port 50 and/or the passages 52 may be provided through the end or side wall 54 of the housing. A subchamber (not shown) may be provided in communication with the chambers 40, for pilot or pre injection of fuel for combustion.

For efficient operation the working chambers 40 are sealed by spring-loaded peripheral or apex seals 56 extending from the rotor 34 to engage the inner surface of the peripheral wall 38, and spring-loaded face or gas seals 58 and end or corner seals 60 extending from the rotor 34 to engage the inner surface of the end walls 54. The rotor 34 also includes at least one spring-loaded oil seal ring 62 biased against the inner surface of the end wall 54 around the bearing for the rotor 34 on the shaft eccentric portion 42.

It is understood that the configuration of the engine 12, e.g. placement of ports, number and placement of seals, etc., may vary from that of the embodiment shown, and that the configuration shown is provided as an example only.

The peripheral wall 38 of the housing 32 includes a plurality of cooling passages 122 through which a liquid coolant (e.g. water) is circulated. It is understood that the position, size and number of the cooling passages shown is illustrative only and that any suitable variation may be used. The cooling passages 122 communicate with each other and with a coolant source, including for example a suitable fluid pump (not shown). In use, the coolant is circulated through the passages 122 and then through a heat exchanger (not shown) to remove excess heat.

In a particular embodiment, the peripheral wall 38 of the housing 32 is manufactured as set forth above. One or more portions 120 of the peripheral wall 38 where the cooling passages 122 are defined is/are formed using an additive manufacturing process, for example a powder bed additive manufacturing process using a laser. The remainder of the peripheral wall 38 is created by adding material directly on the passage portion(s) 120, for example using cold spray. The peripheral wall 38 is then machined to its desired shape, and the surface openings of the passages 122 are defined using a suitable process, for example electric discharge machining (EDM) as set forth above.

Other portions of the housing 32 including passages (e.g. cooling passages) may be similarly manufactured, for example the end walls 54.

It is understood that the above method can be used to manufacture any other suitable type of components, including any other suitable type of passages, e.g. passages for lubricant, fuel, air, other types of coolants. Examples of other components include, but are not limited to, bearing housings, other types of housings, manifolds, heat exchangers, wiring harness, inlet cases.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

1. A method of manufacturing a component with passages extending therethrough, the method comprising:
a) manufacturing a portion of the component using an additive manufacturing process, including creating the passages within the portion of the component; and
b) after step a), adding material directly on the portion of the component using a material build-up process different from the additive manufacturing process of step a) until a predetermined shape for the component is obtained.

2. The method as defined in claim 1, wherein step a) includes forming the portion of the component from a bed of powder material.

3. The method as defined in claim 2, wherein the predetermined shape of the component is larger than the bed of powder material.

4. The method as defined in claim 1, wherein step b) includes embedding the portion of the component in the added material while defining a reference point allowing localisation of the passages after step b).

5. The method as defined in claim 1, wherein the material build-up process of step b) is cold spray.

6. The method as defined in claim 1, wherein the material build-up process of step b) is an additive manufacturing process different from the additive manufacturing process of step a).

7. The method as defined in claim 1, wherein the method further comprises, after step b), machining the component until a desired shape different from the predetermined shape is obtained.

8. The method as defined in claim 7, further comprising using electric discharge machining on a surface of the component to create openings communicating with the passages.

9. The method as defined in claim 1, wherein the passages are cooling passages, the method further comprising, prior to step a), configuring the passages based on cooling requirements of the component and creating a model of the portion including the configured passages, and step a) is performed based on the model.

10. The method as defined in claim 1, wherein step a) is performed to manufacture a plurality of portions of the component each including cooling passages, and step b) includes adding material directly on the portions of the component and interconnecting the portions of the component.

11. A method of manufacturing a wall of a housing of a rotary internal combustion engine, the housing defining an internal cavity sealingly receiving a rotor, the method comprising:
a) manufacturing a portion of the wall using an additive manufacturing process, including creating cooling passages through the portion of the wall; and
b) after step a), building up material directly on the portion of the wall using a manufacturing process different from the additive manufacturing process of step a) to manufacture a remainder of the wall.

12. The method as defined in claim 11, wherein step a) includes forming the portion of the wall from a bed of powder material.

13. The method as defined in claim 12, wherein the wall is larger than the bed of powder material.

14. The method as defined in claim 11, wherein step b) includes embedding the portion of the wall in the added material while defining a reference point allowing localisation of the passages after step b).

15. The method as defined in claim 11, wherein the material build-up process of step b) is cold spray.

16. The method as defined in claim 11, wherein the material build-up process of step b) is an additive manufacturing process different from the additive manufacturing process of step a).

17. The method as defined in claim 11, wherein the method further comprises, after step b), machining the wall.

18. The method as defined in claim 17, further comprising using electric discharge machining on a surface of the wall to create openings communicating with the passages.

19. The method as defined in claim 11, further comprising, prior to step a), configuring the passages based on cooling requirements of the wall and creating a model of the portion including the configured passages, and step a) is performed based on the model.

20. The method as defined in claim 11, wherein step a) is performed to manufacture a plurality of portions of the wall each including cooling passages, and step b) includes adding material directly on the portions of the wall and interconnecting the portions of the wall.
